(19) United States
(12) Patent Application Publication
(10) Pub. No.: US 2015/0013529 A1
(43) Pub. Date: Jan. 15, 2015

(54) MUSIC USER INTERFACE

(71) Applicant: Tymm Twillman, San Francisco, CA (US)

(72) Inventor: Tymm Twillman, San Francisco, CA (US)

(73) Assignee: MISELU INC., San Francisco, CA (US)

(21) Appl. No.: 14/326,416

(22) Filed: Jul. 8, 2014

Related U.S. Application Data
(60) Provisional application No. 61/844,338, filed on Jul. 9, 2013.

(51) Int. Cl. G10H 1/18

(52) U.S. Cl. CPC G10H 1/18
USPC 84/615

(57) ABSTRACT

Embodiments generally relate to a music user interface. In one embodiment, a method includes providing a user interface, where the user interface displays a plurality of musical instrument selections. The method also includes receiving a musical instrument selection. The method also includes controlling a sound type based on the musical instrument selection. The method also includes controlling a responsiveness based on the musical instrument selection.

### CROSS REFERENCE TO RELATED APPLICATIONS

This application claims priority from U.S. Provisional Patent Application No. 61/844,338 entitled “Music User Interface,” filed Jul. 9, 2013, which is hereby incorporated by reference as if set forth in full in this application for all purposes.

### BACKGROUND

The creation of music is a popular activity enjoyed by many people. Various musical instrument devices and music applications enable a user to create music. Such devices and applications provide sounds that emulate the sounds of musical instruments. For example, a keyboard with piano keys when pressed may make piano sounds.

### SUMMARY

Embodiments generally relate to a music user interface. In one embodiment, a method includes providing a user interface, where the user interface displays a plurality of musical instrument selections. The method also includes receiving a musical instrument selection. The method also includes controlling a sound type based on the musical instrument selection. The method also includes controlling a responsiveness based on the musical instrument selection.

### BRIEF DESCRIPTION OF THE DRAWINGS

FIG. 1 is a block diagram of an example system, which may be used to implement the embodiments described herein.

FIG. 2 illustrates an example simplified flow diagram for controlling sound, according to some embodiments.

FIG. 3 illustrates an example simplified user interface that displays multiple musical instrument selections, according to some embodiments.

FIG. 4 is a schematic side view showing example keys of a piano keyboard, according to some embodiments.

### DETAILED DESCRIPTION

Embodiments described herein enable a user to control sound and play a musical instrument. In various embodiments, a processor provides a user interface to a user, where the user interface displays multiple musical instrument selections. When the processor receives a particular musical instrument selection from the user, the processor controls the sound type based on the musical instrument selection and controls the responsiveness based on the musical instrument selection.

As a result, the user has the experience of producing music with more precision and authenticity to particular musical instruments. Embodiments provide the user with a sense of creativity by providing a music user interface having simple and intuitive musical instrument selections.

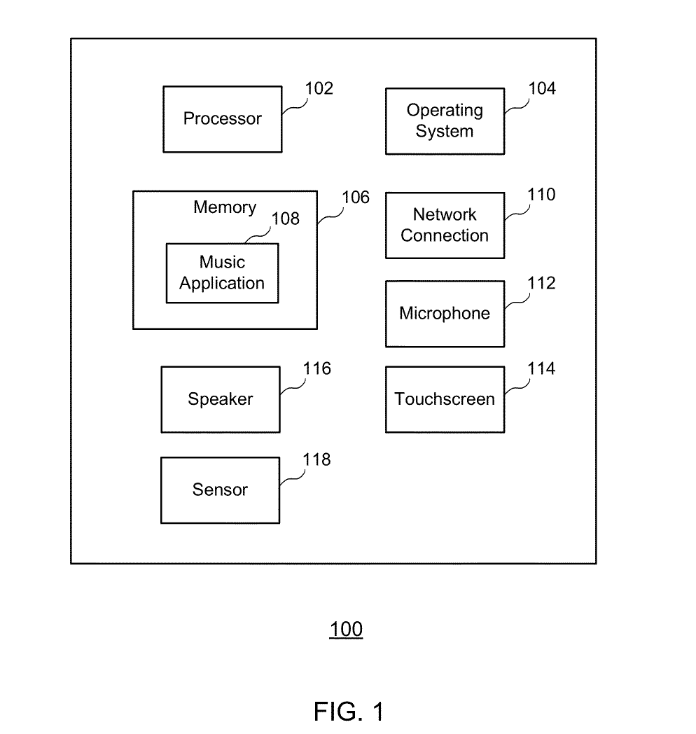

FIG. 1 is a block diagram of an example system 100, which may be used to implement the embodiments described herein. In some embodiments, computer system 100 may include a processor 102, an operating system 104, a memory 106, a music application 108, a network connection 110, a microphone 112, a touchscreen 114, a speaker 116, and a sensor 118. For ease of illustration, the blocks shown in FIG. 1 may each represent multiple units. In other embodiments, system 100 may not have all of the components shown and/or may have other elements including other types of elements instead of, or in addition to, those shown herein.

Music application 108 may be stored on memory 106 or on any other suitable storage location or computer-readable medium. Music application 108 provides instructions that enable processor 102 to perform the functions described herein. In various embodiments, music application 108 may run on any electronic device including smart phones, tablets, computers, etc.

In various embodiments, touchscreen 114 may include any suitable interactive display surface or electronic visual display that can detect the presence and location of a touch within the display area. Touchscreen 114 may support touching the display with a finger or hand, or any suitable passive object, such as a stylus. Any suitable display technology (e.g., liquid crystal display (LCD), light emitting diode (LED), etc.) can be employed in touchscreen 114. In addition, touchscreen 114 in particular embodiments may utilize any type of touch detecting technology (e.g., resistive, surface acoustic wave (SAW) technology that uses ultrasonic waves that pass over the touchscreen panel, a capacitive touchscreen with an insulator, such as glass, coated with a transparent conductor, such as indium tin oxide (ITO), surface capacitance, mutual capacitance, self-capacitance, projected capacitive touch (PCT) technology, infrared touchscreen technology, optical imaging, dispersive signal technology, acoustic pulse recognition, etc.).

In various embodiments, processor 102 may be any suitable processor or controller (e.g., a central processing unit (CPU), a general-purpose microprocessor, a microcontroller, a microprocessor, etc.). Further, operating system 104 may be any suitable operating system (OS), or mobile OS/platform, and may be utilized to manage operation of processor 102, as well as execution of various application software. Examples of operating systems include Android from Google, iPhone OS (iOS), Berkeley software distribution (BSD), Linux, Mac OS X, Microsoft Windows, and UNIX.

In various embodiments, memory 106 may be used for instruction and/or data memory, as well as to store music and/or video files created on or downloaded to system 100. Memory 106 may be implemented in one or more of any number of suitable types of memory (e.g., static random access memory (SRAM), dynamic RAM (DRAM), electrically erasable programmable read-only memory (EEPROM), etc.). Memory 106 may also include or be combined with removable memory, such as memory sticks (e.g., using flash memory), storage discs (e.g., compact discs, digital video discs (DVDs), Blu-ray discs, etc.), and the like. Interfaces to memory 106 for such removable memory may include a universal serial bus (USB), and may be implemented through a separate connection and/or via network connection 110.

In various embodiments, network connection 110 may be used to connect other devices and/or instruments to system 100. For example, network connection 110 can be used for wireless connectivity (e.g., Wi-Fi, Bluetooth, etc.) to the Internet (e.g., navigable via touchscreen 114), or to another device. Network connection 110 may represent various types of connection ports to accommodate corresponding devices or types of connections. For example, additional speakers (e.g., Jawbone wireless speakers, or directly connected speakers) can be added via network connection 110. Also, headphones via the headphone jack can also be added directly, or via wireless interface. Network connection 110 can also include a USB interface to connect with any USB-based device.

In various embodiments, network connection 110 may also allow for connection to the Internet to enable processor 102 to send and receive music over the Internet. As described in more detail below, in some embodiments, processor 102 may generate various instrument sounds coupled together to provide music over a common stream via network connection 110.

In various embodiments, speaker 116 may be used to play sounds and melodies generated by processor 102. Speaker 116 may also be supplemented with additional external speakers connected via network connection 110, or multiplexed with such external speakers or headphones.

In some embodiments, sensor 118 may be a non-contact sensor. In some embodiments, sensor 118 may be an optical non-contact sensor. In some embodiments, sensor 118 may be a near-infrared optical non-contact sensor. As described in more detail below, in various embodiments, sensor 118 enables other embodiments described herein.

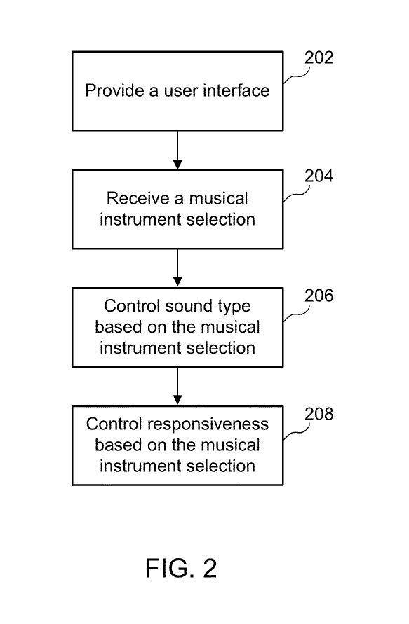

FIG. 2 illustrates an example simplified flow diagram for controlling sound, according to some embodiments. As described in more detail below, various embodiments enable a single user selection to result in both the sound type and the responsiveness of the keys to mimic various physical musical instruments. Referring to both FIGS. 1 and 2, a method is initiated in block 202 where processor 102 provides a user interface to a user, where the user interface displays multiple musical instrument selections.

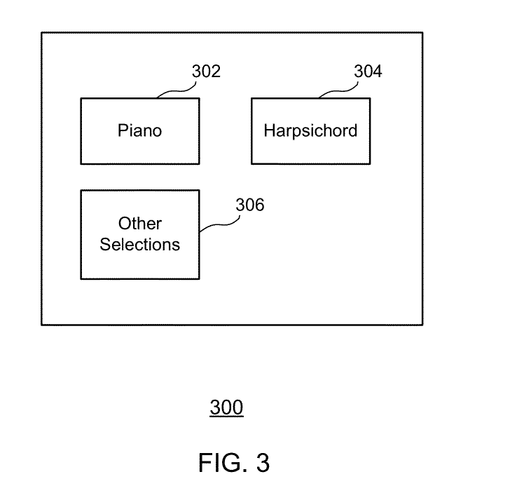

FIG. 3 illustrates an example simplified user interface 300 that displays multiple musical instrument selections, according to some embodiments. As shown, user interface 300 includes example musical instrument selections 302, 304, and 306. For example, in some implementations, musical instrument selection 302 is a piano. In some implementations, musical instrument selection 304 is a harpsichord. In some implementations, musical instrument selection 306 is other selections. For example, if the user selected musical instrument selection 306, processor 102 may provide other sound types (e.g., synthesized sounds). In various implementations, such synthesized sounds may include various musical instrument sounds (e.g., types of wind instrument sounds, types of horn instrument sounds, types of string instrument sounds, etc.).

A various implementations, a selection of musical instrument selection 302 provides the user with a combination of a sound type and a responsiveness. In some implementations, the sound type may be a piano sound, a harpsichord sound, etc., depending on the musical instrument selection. For example, a single selection of musical instrument selection 302 provides the user with a combination of a piano sound and piano responsiveness. Similarly, a single selection of musical instrument selection 304 provides the user with a combination of a harpsichord sound and harpsichord responsiveness. As indicated above, these are example musical instrument selections, and others are possible depending on the particular embodiment. Examples of responsiveness are described in more detail below.

Referring again to FIG. 2, in block 204, processor 102 receives a musical instrument selection from the user. For example, after the user selects musical instrument selection 302, processor 102 receives that musical instrument selection (e.g., piano). As described in more detail below, processor 102 provides the respective musical instruments sound when the user presses a key on a musical instrument (e.g., a key on a piano keyboard).

In block 206, processor 102 controls the sound type based on the musical instrument selection. In various implementations, if the user selects a particular musical instrument selection, processor 102 controls the sound type based on that musical instrument selection in that, in response to the user pressing a key (e.g., pressing a key on a piano keyboard), processor 102 provides a sound that mimics a particular musical instrument. For example, in some implementations, if the user selects musical instrument selection 302, processor 102 controls the sound of the keyboard such that the sound mimics a piano. In some implementations, if the user selects musical instrument selection 304, processor 102 controls the sound of the keyboard such that the sound mimics a harpsichord.

In various embodiments, the sound type is a predetermined sound type associated with any particular type of musical instrument (e.g., piano, harpsichord, etc.) or associated with any other sound (e.g., synthesized sounds). Based on the sound type processor 102 may access a sound input the form of sound waves, in the form of an audio file, or in any suitable form, and from any suitable storage location, device, network, etc. In various embodiments, an audio file may be a musical instrument digital interface (MIDI) file, or an audio file in any other suitable audio format.

In some embodiments, processor 102 may receive the sound input via any suitable music device such as a musical keyboard. The musical keyboard may be a device that connects to network connection 110. The musical keyboard may also be a local application that uses touchscreen 114 to display a musical keyboard, notation, etc.

In block 208, processor 102 controls the responsiveness based on the musical instrument selection. In various implementations, if the user selects a particular musical instrument selection, processor 102 controls the responsiveness based on that musical instrument selection in that, in response to the user pressing a key (e.g., pressing a key on a piano keyboard), processor 102 provides the responsiveness such that the responsiveness mimics a behavior of a particular musical instrument. In various implementations, the responsiveness may be based on a trigger point (e.g., the trigger point of a key). In various implementations, the trigger point is the position of a particular key at which the key when pressed produces a sound. Trigger points are described in more detail below.

For example, in some embodiments, if the user selects musical instrument selection 302, processor 102 controls the responsiveness of the keyboard such that keys when pressed mimic the behavior of a piano. For example, when the user presses a given key, processor 102 may cause a corresponding piano sound to begin before the key reaches the bottom of its range of motion. In various implementations, the trigger point may be positioned in a predetermined location along the range of motion before a key reaches the bottom of its range of motion. The particular position of the trigger point will depend on the particular implementation. Trigger points and other aspects of responsive may vary depending on the particular embodiment.

In some implementations, the volume of a particular sound may vary depending on the velocity of the moving key. For example, in some implementations, the volume of the piano sound may vary depending on the velocity of the moving key.

In some embodiments, if the user selects musical instrument selection 304, processor 102 controls the responsiveness of the keyboard such that the keys when pressed mimic the behavior of harpsichord. For example, when the user presses a given key, processor 102 may cause a corresponding harpsichord sound to begin when the key reaches the bottom of its range of motion. In other words, in some implementations, the trigger point may be located at the bottom of a key's range of motion.

In some implementations, the volume of a particular sound may remain constant (e.g., remain the same) regardless of the velocity of the moving key. For example, in some implementations, the volume of the harpsichord sound may remain the same regardless of the velocity of the moving key.

In various embodiments, processor 102 may use any suitable algorithm to control the responsiveness of a piano key when the user depresses the key. For example, in some embodiments, processor 102 may use an algorithm that interacts with a sensor that senses the positions of the keys.

In various embodiments, the responsiveness of the keyboard may include various aspects. For example, responsiveness of the keyboard (e.g., key responses) may include a single triggering point, multiple trigger points, velocity, resistance, etc. In various embodiments, a combination of these and other aspects may correspond to behaviors and various musical instruments, which may include keyboard instruments, non-keyboard musical instruments (e.g., string, woodwind, brass, percussion, etc.), as well as synthesizer instruments.

As indicated above, in some embodiments, sensor 118 of FIG. 1 is non-contact sensor (e.g., an optical non-contact sensor) that provides varying levels or degrees of responsiveness of a piano keyboard when keys are depressed.

In various embodiments, because a non-contact sensor is used, the sensor signal generated from a key press of a corresponding key is a continuous analogue variable (rather than a discreet variable). In other words, the information determined from the movement of a given key is continuous.

In various embodiments, sensor 118 may include multiple emitters and multiple sensors such that an emitter-sensor pair may correspond to and interact with a different key to determine the position of the key. In some embodiments, the amount of occlusion (e.g., signal strength) of a given sensor varies as the corresponding key moves past (e.g., toward and away) from the sensor. In some embodiments, a given occlusion may correspond to a particular key position. As such, processor 102 may ascertain the position of a given key based on the occlusion of the corresponding sensor. Furthermore, processor 102 may assign a trigger point at which the position of the key triggers a sound.

In various embodiments, sensor 118 is a non-contact sensor that utilizes electromagnetic interference to precisely determine the position of each key. Sensor 118 detects key movement when a given key moves past its corresponding sensor.

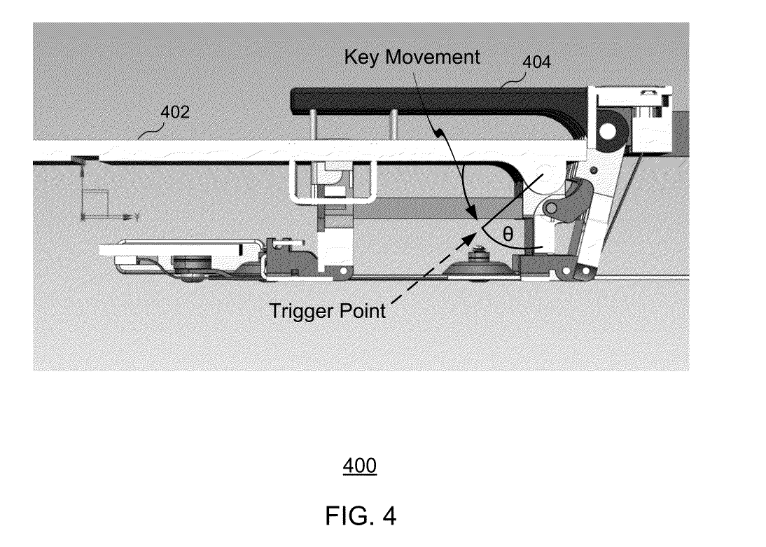

FIG. 4 is a schematic side view showing example keys of a piano keyboard, according to some embodiments. FIG. 4 shows a white key 402 and a black key 404. As shown, white key 402 moves or traverses (rotates along) a range of motion when the user presses the key (e.g., downward on the left portion of white key 402). As described in more detail below, when white key 402 reaches a trigger point at a predetermined threshold angle theta, processor 102 causes a sound to be generated in response to white key 402 reaching the trigger point. As described in more detail below, different predetermined threshold angles correspond to different trigger points. These implementations also apply to the black key 404, as well as to the other keys (not shown) of the keyboard.

In some embodiments, a given key traverses (rotates through) angle thresholds theta 1 and theta 2 (not shown), where each angle corresponds to a different musical instrument. For example, theta 1 may correspond to a piano, and theta 2 may correspond to a harpsichord. Each angle threshold theta 1 and theta 2 may correspond to a different trigger point. In some implementations, the key may travel linearly instead of rotationally, where distance thresholds may substitute angle thresholds.

In some embodiments, processor 102 assigns a different position of triggering (trigger point) to different analog representations of the positions of the keys.

For example, referring again to FIG. 3, if a piano 302 is selected, when a given key travels downward and reaches theta 1 (piano), processor 102 may cause a corresponding piano sound to begin even before the key reaches the bottom of its range of motion. If a harpsichord is selected, theta 2 may be at 0 degrees. As such, when a given key travels downward and reaches theta 2 (harpsichord), processor 102 may cause a corresponding harpsichord sound to begin when the key reaches the bottom of its range of motion.

As indicated above, other musical instrument selections are possible. For example, in one embodiment, a musical instrument selection may an organ, where theta may substantially be at 45 degrees. As such, the trigger point may be half way down such that an organ sound is generated when a key is pressed half way down.

In some embodiments, processor 102 may enable the user to have more control over responsiveness by enabling the user to select a particular trigger point. In other words, in some embodiments, processor 102 may enable a user to modify the feel of the keyboard such that the responsiveness is not tied to a particular musical instrument. For example, processor 102 may enable the user to modify the responsiveness such that the user can play lighter and still produce sound. In some embodiments, processor 102 may enable some keys to have a different responsiveness than other keys. For example, if the user plays more lightly with the left hand compared to the right hand (e.g., naturally or due to a physical limitation, etc.), processor 102 may enable the user to modify the responsiveness to be higher for the left hand. As such, the user may play more lightly with the left hand and more heavily with the right hand and still produce a relatively even sound across the keyboard.

In some embodiments, varying resistance may be achieved using electromagnetic technologies. For example, in some embodiments, magnets and spacers may be used to provide resistance when keys are pressed. In some embodiments, the position of magnets and spacers may be changed (e.g., lowered/raised) in order to modify the resistance of keys. In some embodiments, the magnets may be held in place by clips, with the spacers between magnets. In some embodiments, springs may be used to provide resistance, and different spring tensions may be used to modify the resistance of the springs.

Embodiments described herein provide various benefits. For example, embodiments enable professional and non-professional musicians to quickly and conveniently control what particular sounds a musical instrument makes, and also the responsiveness of the keys of a music device when the user presses the keys. Embodiments also provide simple and intuitive selections for creating music.

Although the description has been described with respect to particular embodiments thereof, these particular embodiments are merely illustrative, and not restrictive. Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a tangible medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method comprising:
providing a user interface, wherein the user interface displays a plurality of musical instrument selections;
receiving a musical instrument selection;
controlling a sound type based on the musical instrument selection; and
controlling a responsiveness based on the musical instrument selection.

2. The method of claim 1, wherein the musical instrument selection is a piano.

3. The method of claim 1, wherein the musical instrument selection is a harpsichord

4. The method of claim 1, wherein the musical instrument selection provides a combination of a sound type and a responsiveness.

5. The method of claim 1, wherein the controlling of the sound type comprises providing a sound that mimics a particular musical instrument.

6. The method of claim 1, wherein the controlling of the responsiveness comprises providing the responsiveness such that the responsiveness mimics a behavior of a particular musical instrument.

7. The method of claim 1, wherein the controlling of the responsiveness comprises providing the responsiveness such that the responsiveness mimics a behavior of a particular musical instrument, and wherein the responsiveness is based on a trigger point.

8. A non-transitory computer-readable storage medium carrying one or more sequences of instructions thereon, the instructions when executed by a processor cause the processor to perform operations comprising:
providing a user interface, wherein the user interface displays a plurality of musical instrument selections;
receiving a musical instrument selection;
controlling a sound type based on the musical instrument selection; and
controlling a responsiveness based on the musical instrument selection.

9. The computer-readable storage medium of claim 8, wherein the musical instrument selection is a piano.

10. The computer-readable storage medium of claim 8, wherein the musical instrument selection is a harpsichord

11. The computer-readable storage medium of claim 8, wherein the musical instrument selection provides a combination of a sound type and a responsiveness.

12. The computer-readable storage medium of claim 8, wherein, to control the sound type, the instructions further cause the processor to perform operations comprising providing a sound that mimics a particular musical instrument.

13. The computer-readable storage medium of claim 8, wherein, to control the responsiveness, the instructions further cause the processor to perform operations comprising providing the responsiveness such that the responsiveness mimics a behavior of a particular musical instrument.

14. The computer-readable storage medium of claim 8, wherein, to control the responsiveness, the instructions further cause the processor to perform operations comprising providing the responsiveness such that the responsiveness mimics a behavior of a particular musical instrument, and wherein the responsiveness is based on a trigger point.

15. An apparatus comprising:
one or more processors; and
logic encoded in one or more tangible media for execution by the one or more processors, and when executed operable to perform operations including:
providing a user interface, wherein the user interface displays a plurality of musical instrument selections;
receiving a musical instrument selection;
controlling a sound type based on the musical instrument selection; and
controlling a responsiveness based on the musical instrument selection.

16. The apparatus of claim 15, wherein the musical instrument selection is a piano.

17. The apparatus of claim 15, wherein the musical instrument selection is a harpsichord

18. The apparatus of claim 15, wherein the musical instrument selection provides a combination of a sound type and a responsiveness.

19. The apparatus of claim 15, wherein, to control the sound type, the logic when executed is further operable to perform operations comprising providing a sound that mimics a particular musical instrument.

20. The apparatus of claim 15, wherein, to control the responsiveness, the logic when executed is further operable to perform operations comprising providing the responsiveness such that the responsiveness mimics a behavior of a particular musical instrument.
